(19) United States
(12) Patent Application Publication
(10) Pub. No.: US 2006/0231580 A1
(43) Pub. Date: Oct. 19, 2006

(54) TWIST LOCK FLUID DISPENSING VALVE

(75) Inventors: Rebecca A. LAWSON, Florence, SC (US); James F. KICK, Town & Country, MO (US)

Correspondence Address: CLAUSEN MILLER, P.C, SUITE 1600, 10S. LASALLE STREET, CHICAGO, IL, 60603, US

(73) Assignee: SONOCO DEVELOPMENT, INC., Hartsville, SC (US)

(21) Appl. No.: 10/907,726

(22) Filed: Apr. 13, 2005

(51) Int. Cl. B67D 3/00

(52) U.S. Cl. 222/519

(57) ABSTRACT

A twist-lock valve for use with a container for dispensing fluid material such as ink. The valve has a single sealing surface and comprises a base portion having a valve seat and a twist cap having a flexible annular rim that seats against the valve seat when the valve is closed. The valve has multiple settings or positions to accommodate different types of fluids, particularly fluids having different viscosities.

### FIELD OF THE INVENTION

This patent relates to a twist-lock valve for use with a fluid dispensing container. More particularly, this patent relates to a twist-lock valve for use with an ink cartridge wherein the valve can be adjusted to dispense inks of varying viscosities.

### DESCRIPTION OF THE RELATED ART

Modern ink cartridges for printing presses typically comprise an open ended hollow tubular body, a moveable plunger inserted into one end of the body and a stationary dispensing fitment attached to the opposite end. The dispensing fitment covers the dispensing end of the tubular body and incorporates a valve for opening and closing the cartridge. Ink is extruded from the cartridge when the plunger is forced toward the dispensing end either manually or, more commonly, by pneumatic pressure.

Commonly owned Johanson U.S. Pat. No. 6,547,108, incorporated herein by reference, is directed to a pressure-activated flexible valve for an ink cartridge. The valve has a single sealing surface and comprises an inner component having a dish-shaped valve seat and an outer component having an annular rim that abuts the valve seat when the valve is closed. In a key aspect of the Johanson invention, the outer component has an annular flexible portion configured to flex upward and outward when subjected to sufficient pressure from the container fluid material, moving the annular rim between a closed position and an open position.

While this valve is suitable for its intended purpose, it may not be suitable for use with all types of inks, including highly viscous ink. It can be difficult to extrude highly viscous inks through the relatively narrow annular opening between the valve rim and seat. The valve can also result in limited flow when used with a pneumatic hand-gun.

One solution to these problems is for the user to stock multiple cartridges for use in different applications and with inks of different viscosities. But this solution requires additional storage space and can result in increased printing costs.

What is needed is a single adjustable valve or nozzle that is capable of dispensing a variety of inks under a variety of applications, including inks having different viscosities. The present invention fulfills this need.

Thus it is an object of the present invention to provide a fluid dispensing valve that can be used with fluids of different viscosities.

Yet another object of the present invention is to provide a pressure-activated valve that can be set to a position that does not allow any flow of ink from the container.

Still another object of the present invention is to provide an ink cartridge that can dispense inks having very high and low viscosities.

Another object of the present invention is to provide an ink cartridge that works well with both automatic ink dispensing equipment hand dispensers.

Further and additional objects will appear from the description, accompanying drawings, and appended claims.

### SUMMARY OF THE INVENTION

The present invention is a twist-lock valve for an ink cartridge. The twist-lock valve typically forms part of a dispensing fitment comprising a cup-shaped base and a cap mounted on the base.

The base comprises a covering portion with a centrally located aperture, a sidewall extending upward from the periphery of the covering portion that fits snugly against the inside wall of the cartridge, a cylindrical neck extending upward from the periphery of the aperture, and a dome-shaped valve seat connected to the inside wall of the neck by bridges.

The neck has a large bead disposed about the lower portion of the neck near the covering portion, and three smaller beads or ribs disposed about the upper portion of the neck near the valve seat. A diagonal groove is disposed in the large bead.

The cap is reciprocally mounted onto the neck of the base in tongue and groove fashion. The cap comprises a generally cylindrical sidewall and a flexible annular rim extending radially inward from the upper end of the sidewall. The flexible rim flexes away from the valve seat when subjected to a predetermined pressure from the ink or other fluid inside the cartridge. The cap also comprises a tongue (“undercut”) section near the lower end of the cap sidewall and a rib located about midway between the sidewall ends.

The valve has four positions or settings: CLOSED, VALVE, OPEN and FULLY OPEN. The valve is moved from one setting to another by twisting or rotating the cap with respect to the base and simultaneously pulling the cap away from the base.

In the CLOSED position, the flexible annular rim is flexed tightly against the valve seat to prevent leakage. This setting is used for filling and shipping the ink cartridges.

Twisting and pulling on the cap causes the tongue to ride up the groove in the base and also causes the cap second rib to snap over the first small bead located on the interior portion of the base neck. This twisting and pulling moves the cap into the VALVE position. In the VALVE position, the cap rib is located in the space between the first and second beads of the neck. The flexible annular rim is still seated against the valve seat but is not as flexed as it was in the CLOSED position, so the flexible annular rim can now be flexed opened (moved off the valve seat) by sufficient pressure from within the cartridge. The VALVE setting is used for low viscosity inks and varnishes.

Twisting and pulling the cap further causes the tongue to ride further up the groove and also causes the cap rib to snap over the neck second bead, moving the cap to the OPEN position. In the OPEN position, the flexible rim is spaced slightly (about 0.050 inches) above the valve seat, exposing an annular opening for dispensing a mid-range viscosity fluid.

Twisting and pulling the cap still further moves the cap into the FULLY OPEN position, in which the flexible rim is spaced further away (about 0.100 inches) from the valve seat, exposing a larger annular opening for dispensing high viscosity fluids.

### THE DRAWINGS

FIG. 1 is cross-sectional view of a dispensing fitment according to the present invention with the cap shown in the CLOSED position.

FIG. 2 is a top plan view of the dispensing fitment base of FIG. 1.

FIG. 3 is a close up of a portion of the dispensing fitment of FIG. 1 with the cap shown in the VALVE position.

FIG. 3a is a close up view of a portion of the dispensing fitment of FIG. 1 with the cap shown in the OPEN position.

FIG. 3b is a close up view of a portion of the dispensing fitment of FIG. 1 with the cap shown in the FULLY OPEN position.

FIG. 4 is a cross-sectional view of the cap portion of the dispensing fitment of FIG. 1.

FIG. 5 is a close up view of the base portion of the dispensing fitment of FIG. 1.

### DETAILED DESCRIPTION OF THE INVENTION

For purposes of illustration, the twist-lock valve of the present invention will be described as it might be used with a tubular paperboard ink cartridge for dispensing printing ink, although it should be understood that the twist-lock valve may be used with other types of containers, including but not limited to metal containers, squeeze tubes and bags, and with other types of fluid materials, including gases, powders, emulsions and pastes. The twist-lock valve is depicted in the figures pointing up, although in actual use the valve typically would be pointing down.

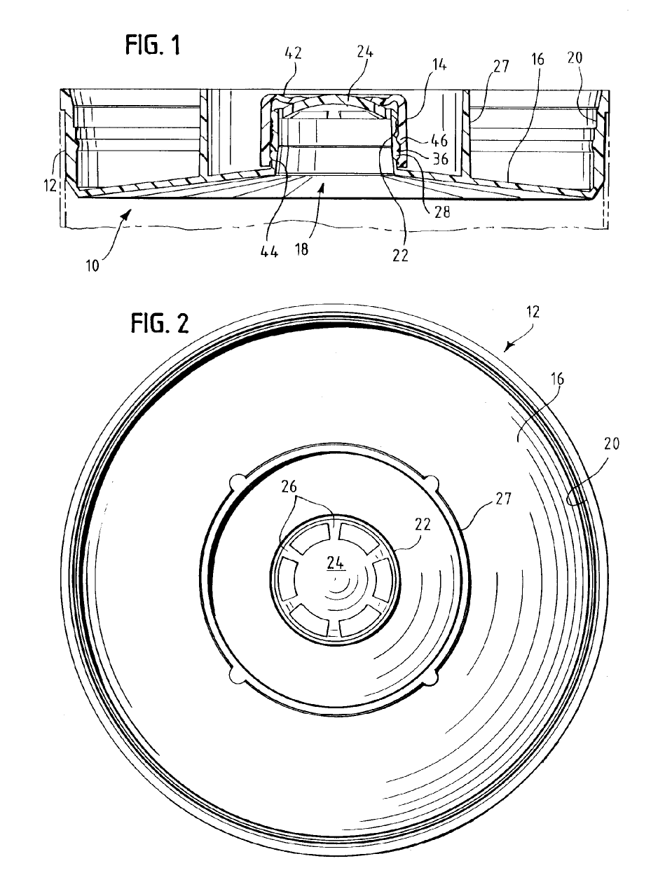

FIG. 1 shows a preferred embodiment of a dispensing fitment 10 incorporating the twist-lock valve of the present invention. The dispensing fitment 10 typically is inserted into an end of a fluid dispensing container such as an ink cartridge (shown in phantom lines). A plunger typically inserted into the opposite end of the ink cartridge and is configured to mate closely with the dispensing fitment 10 to minimize wasted fluid.

The dispensing fitment 10 comprises a base 12 and a cap 14 mounted onto the base 12. The base 12 is generally cup-shaped and comprises a covering portion 16, a sidewall 20 extending upward from the periphery of the covering portion 16, a centrally disposed aperture 18, and a cylindrical neck portion 22 extending upward from the periphery of the aperture 18. An optional stiffening ring 27 may extend upward from the covering portion 16 between the neck 22 and the sidewall 20. The sidewall 20, neck 22 and stiffening ring 27 are concentric.

The base sidewall 20 fits snugly into the dispensing end of a cylindrical cartridge body and may have a flange that extends radially outward from the top edge of the sidewall 20 such that the underside of the flange abuts the upper edge or rim of the cartridge body when the base 12 is fully inserted into the body. The sidewall 20 may be affixed to the inner surface of the cartridge body by adhesive or other means. Alternatively, the base sidewall 20 can extend downward from the covering portion 16 such a distance that it serves as the cartridge body, thereby eliminating the need for a separate cartridge body.

As perhaps best shown in FIGS. 2 and 5, the base 12 further comprises a dome-shaped valve seat 24 located over the aperture 18 and attached to the neck 22 bridges 26 extending radially from the valve seat 24. Spaces between the bridges 26 serve as openings through which the fluid may be dispensed.

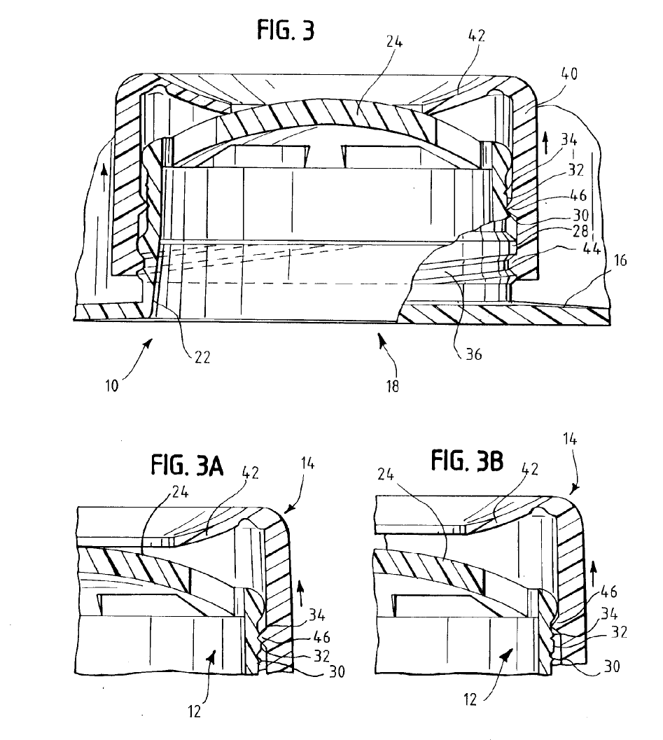

Referring to FIGS. 3 and 5, a large bead 28 is circumferentially disposed about the lower portion of the neck 22 near the covering portion 16. Three smaller beads 30, 32, 34 are circumferentially disposed about the upper portion of the neck 22. The three smaller beads 30, 32, 34 are spaced closely together and define two grooves spaced about 0.050 inches apart. As shown in FIG. 5, a large groove 36 runs diagonally through the large bead 28.

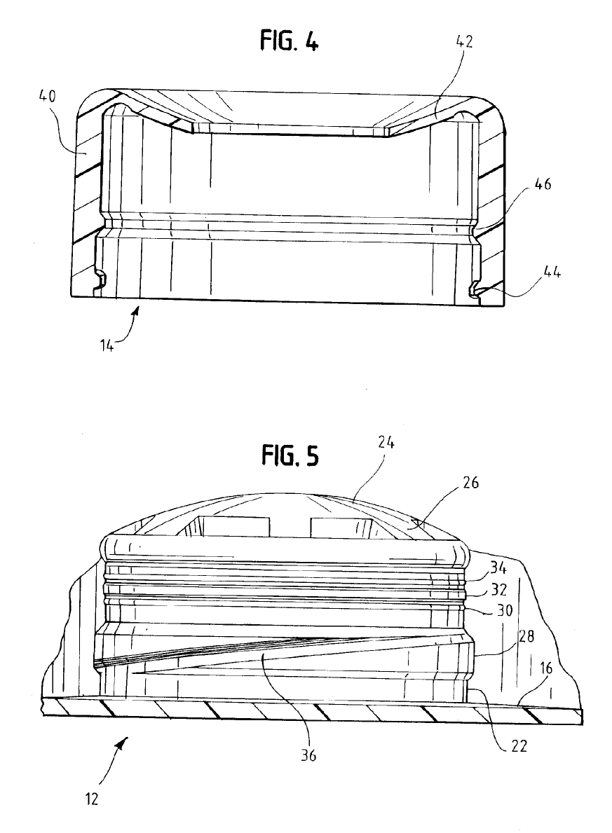

Referring to FIGS. 3 and 4, the cap 14 comprises a generally cylindrical sidewall 40 and a flexible annular rim 42 extending radially inward from the upper end of the sidewall 40. The flexible rim 42 flexes up and away from the valve seat 24 when subjected to a predetermined pressure from the ink or other fluid inside the cartridge. As shown in FIG. 4, the cap further comprises a tongue 44 located on the inside of the cap sidewall 40 near the lower end of the sidewall 40, and a rib 46 extending around the circumference of the inside of the cap sidewall 40 about midway between the top and bottom of the sidewall 40.

The cap 14 is reciprocally mounted onto the neck 22 of the base 12 in tongue and groove fashion. Specifically, cap tongue 44 fits within the groove 36 located on the outside of the base neck 22. Twisting (rotating) the cap 12 and simultaneously pulling the cap 12 away from the base 14 causes the cap tongue 44 to ride up the groove 36 in the base and also causes the cap rib 46 to snap over the three small beads 30, 32, 34 located higher up on the base neck 22, as explained in more detail below.

The cap 14 has four positions or settings: CLOSED, VALVE, OPEN and FULLY OPEN. In the CLOSED position (FIG. 1), the cap tongue 44 is located below base rib 28 and the cap rib 46 is located below the first bead 30 located on the base neck 22. The cap's flexible annular rim 42 is flexed tightly against the dome-shaped valve seat 24 to prevent any fluid from escaping from the cartridge. This setting is used for filling and shipping the ink cartridges.

Twisting and pulling on the cap 14 causes the tongue 44 to ride up the groove 36 in the base 12 and also causes the cap rib 46 to snap over the first bead 30 located on the inside of the base neck 22 and into the groove defined by the first and second beads 30, 32 as shown in FIG. 3. In the VALVE position the cap 14 is displaced about 0.050 inches (the width of the first bead 30) above its CLOSED position. The flexible annular rim 42 is still seated against the valve seat 24 as shown in FIG. 3 but is not as stressed as it was in the CLOSED position, so the flexible annular rim 42 can now be flexed opened (moved off the valve seat 24) by sufficient pressure from within the cartridge. The VALVE setting is used for low viscosity inks and varnishes.

Twisting and pulling the cap 14 further causes the tongue 44 to ride further up the groove 36 and also causes the cap rib 46 to snap over the neck second bead 32, moving the cap 14 to the OPEN position. In the OPEN position (FIG. 3A), the cap 14 is displaced about 0.050 inches higher than its VALVE position and the annular flexible rim 42 is spaced about 0.050 inches above the valve seat 24, exposing an annular opening for dispensing a mid-range viscosity fluid.

Twisting and pulling the cap 14 still further causes the tongue 44 to ride still further up the groove 36 in the base 12 and also causes the cap rib 46 to snap over the neck third bead 34. In the FULLY OPEN position (FIG. 3B) the cap 14 is displaced about 0.050 inches (the width of the third bead 34) above its OPEN position and about 0.150 inches about its CLOSED position. The flexible rim 42 is spaced further away (about 0.100 inches) from the valve seat 24, exposing a larger annular opening for dispensing high viscosity fluids.

The cap 14 may be opened and closed as needed by twisting and pulling or pushing on the cap 14. In the CLOSED position the valve is “locked” and will not open under normal pressures. In the VALVE position the valve is closed but may be activated (opened) by sufficient pressure from the ink inside the cartridge. In the OPEN and FULLY OPEN positions the valve is opened a discrete distance to allow for the dispensing of mid-range and high viscosity inks respectively.

The cap 14 preferably is made of DuPont HYTREL™ plastic or any other material having sufficient elasticity. The base preferably is made from high density polyethylene or any other suitably stiff plastic.

Thus there has been described a pressure-activated twist-lock valve having a single sealing surface and multiple settings or positions to accommodate different types of fluids, particularly fluids having different viscosities. The twist lock valve allows the same cartridge to be used with all types of inks and different equipment. The valve also solves the problem of limited flow from hand dispensers.

Other modifications and alternative embodiments of the invention are contemplated which do not depart from the scope of the invention as defined by the foregoing teachings and appended claims. It is intended that the claims cover all such modifications that fall within their scope.

What is claimed is:

1. A valve for use with a fluid dispensing container, the valve comprising:
a base comprising an upwardly extending neck portion and a valve seat connected to the neck portion by bridges, the neck portion comprising an outer wall, an inner wall, a diagonal groove disposed about a lower portion of the neck outer wall, and one or more beads circumferentially disposed about an upper portion of the neck outer wall; and
a cap reciprocally mounted to the neck portion and comprising a downwardly extending sidewall, a flexible annular rim extending radially inward from the sidewall, a tongue located on the inside surface of the cap sidewall near a lower end of the sidewall, and a rib extending radially inward from the cap sidewall, the flexible annular rim being in sealing engagement with the valve seat when the cap is in its lowest position relative to the neck;
wherein twisting and pulling the cap causes the tongue to travel up the groove in the base and the rib to snap over the one or more beads.

2. The valve of claim 1 wherein raising and lowering the cap causes the cap to travel between at least three discrete positions, including:
a first, lowest position wherein the flexible rim is seated against the valve seat under sufficiently stressed conditions that the valve cannot be opened under normal pressure from the fluid;
a second position wherein the flexible rim is seated against the valve seat but can be opened in response to pressure from the fluid within the container; and
a third position wherein the flexible rim is displaced a first discrete distance away from the valve seat, exposing an annular opening between the flexible rim and the valve seat for dispensing a higher viscosity fluid.

3. The valve of claim 1 wherein the neck further comprises a large bead disposed about a lower portion of the neck outer wall and the groove is disposed within the bead.

4. The valve of claim 1 wherein the cap is formed from resilient plastic and the base and neck are formed from relatively rigid plastic.

5. The valve of claim 1 wherein the fluid dispensing container comprises an open-ended hollow cylindrical body and the base further comprises a portion for covering an end of the cylindrical body, a sidewall extending upward from the periphery of the covering portion and adapted to fit snugly against the cylindrical body and a centrally disposed aperture, and wherein the neck portion extends upward from the periphery of the aperture.

6. The valve of claim 5 wherein the base further comprises a stiffening ring extending upward from the covering portion between the neck and the sidewall, the sidewall, neck and stiffening ring being concentric.
